(19) United States
(12) Patent Application Publication
(10) Pub. No.: US 2003/0214109 A1
(43) Pub. Date: Nov. 20, 2003

(54) Miniature skateboard

(76) Inventor: Clemens V. Hedeen JR., Sturgeon Bay, WI (US)

Correspondence Address: ELLSWORTH R. ROSTON, ESQ., FULWIDER PATTON LEE & UTECHT, LLP, TENTH FLOOR, 6060 CENTER DRIVE, LOS ANGELES, CA, 90066, US

(21) Appl. No.: 10/150,279

(22) Filed: May 17, 2002

(51) Int. Cl. B62M 1/00

(52) U.S. Cl. 280/87.042

(57) ABSTRACT

A miniature skateboard includes a platform having a size preferably less than that of a user's shoe. Axles are attached to the undersurface of the platform at longitudinally spaced positions. Wheels are attached to axles at laterally spaced positions. A support member coupled to a pivot pin near the platform rear is manually pivotable between first and second positions. In the first position, the support member is disposed under the platform. In the second position, the support member extends rearwardly from the platform to support the user's other foot. A clip on the platform retains the skateboard on the user's clothes (e.g., belt) when the skateboard is not being used.

This invention relates to a miniature skateboard constructed to provide for a disposition of one or both of a user's feet on the skateboard.

### BACKGROUND OF THE PREFERRED EMBODIMENTS OF THE INVENTION

Skateboards have been popular for decades for use by pre-teenagers and teenagers. The skateboard has generally included a platform on which the user has disposed one of his feet when he is pedaling with the other foot and on which the user has disposed both of his feet when he is coasting or when he is performing stunts on the skateboard.

The skateboards now in use are relatively large and bulky. For example, the platform on the skateboard may have a length of approximately eighteen inches (18″) and may have a width of approximately six inches (6″). This has caused the skateboard to be relatively heavy and cumbersome. The size and weight of the skateboard, furthermore, have reduced the challenge to the skateboard user in operating the skateboard and in performing stunts on the skateboard. This is particularly true when the user is skilled in the use of the skateboard.

### BRIEF DESCRIPTION OF A PREFERRED EMBODIMENT OF THE INVENTION

A miniature skateboard includes a platform having a size preferably less than that of a user's shoe. For example, the miniature skateboard may have a length approximately six inches (6″) and a width of approximately three inches (3″). Axles are attached to the undersurface of the platform at longitudinally spaced positions. Wheels are attached to the axles at laterally spaced positions.

A support member coupled to a pivot pin near the platform rear is manually pivotable between first and second positions. In the first position, the support member is disposed under the platform. In the second position, the support member extends rearwardly from the platform to support the user's other foot when the skateboard is coasting or when the user is performing stunts on the skateboard. The support member also acts as a brake when depressed to stop or slow the skateboard and aids in performing certain tricks and stunts. A clip on the platform retains the skateboard on the user's clothes (e.g., the user's pants belt) when the skateboard is not being used.

### BRIEF DESCRIPTION OF THE DRAWINGS

In the Drawings:

FIG. 1 is a schematic perspective view of a miniature skateboard coupled to the pants belt of a user to facilitate the transport of the skateboard by the user when the user is not operating the skateboard;

FIG. 2 is an enlarged top plan view of the miniature skateboard show in FIG. 1;

FIG. 3 is an enlarged top plan view of the miniature skateboard and shows a support member forming a part of the miniature skateboard and pivotable to a position relative to a platform on the skateboard to provide for a disposition of one of the user's feet on the platform and the other of the user's feet on the support member;

FIG. 4 is a front elevational view of the skateboard and shows the support member in an extended position relative to the platform to provide a support for the user's feet on the platform and the support member; and

FIG. 5 is an enlarged fragmentary perspective view showing the disposition of one of the user's feet on the platform and the sole of the other of the user's feet on the support member.

### DETAILED DESCRIPTION OF A PREFERRED EMBODIMENT OF THE INVENTION

A miniature skateboard generally indicated at 10 includes a platform 12. The platform 12 may be made from a suitable material such as wood or a plastic. The platform 12 may have dimensions preferably less than those of a user's shoe. For example, the platform 12 may have a length of approximately six inches (6″) and a width of approximately two inches (2″). The platform 12 is sufficiently thick so that it supports the weight of the user when the user stands on the platform.

A pair of axles 14 are suitably attached to the bottom surface of the platform 12 in a conventional manner at longitudinally spaced positions along the platform. A separate pair of wheels 16 are attached to each individual one of the axles 14 in a conventional manner. The wheels 16 on each axle 14 are laterally spaced from each other and are adapted to be rotated in forward and rearward directions.

A pivot pin 18 extends through the platform at a position towards the rear of the platform. A support member 20 has a hole 22 which receives the pivot pin 18 to provide for a pivotable movement of the support member on the pivot pin as a fulcrum. The support member 20 may be made from a suitable material such as wood or a plastic.

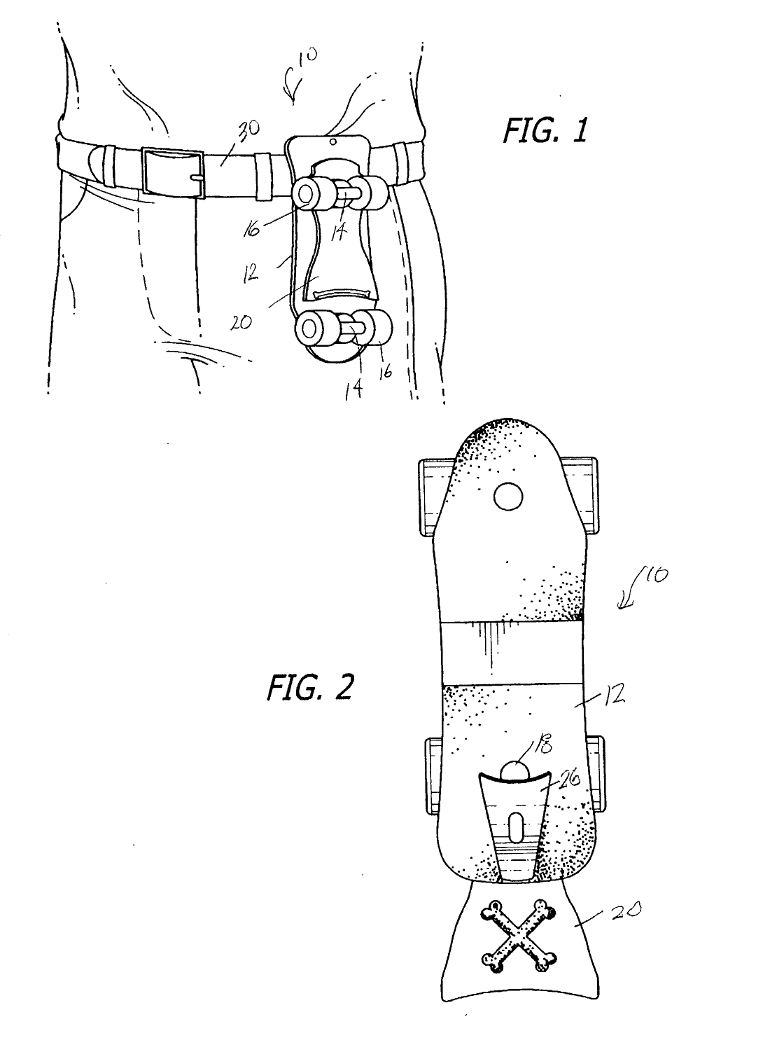

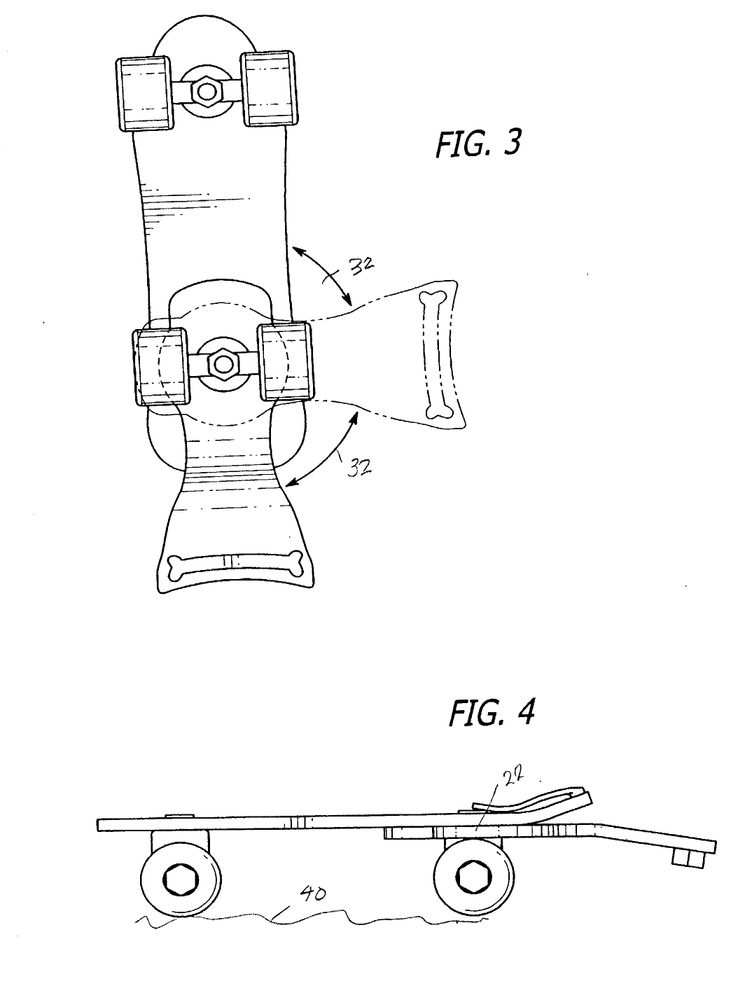

The support member 20 is pivotable on the pivot pin 18 between a first position and a second position. In the first position (FIG. 1), the support member 20 is disposed below the platform 12 as shown in FIG. 1 and performs no function except to provide an additional support for the user's foot which is disposed on the platform. In the second position (FIG. 2), the support member 20 extends rearwardly from the platform 12 so that it can be considered to constitute an extension of the platform.

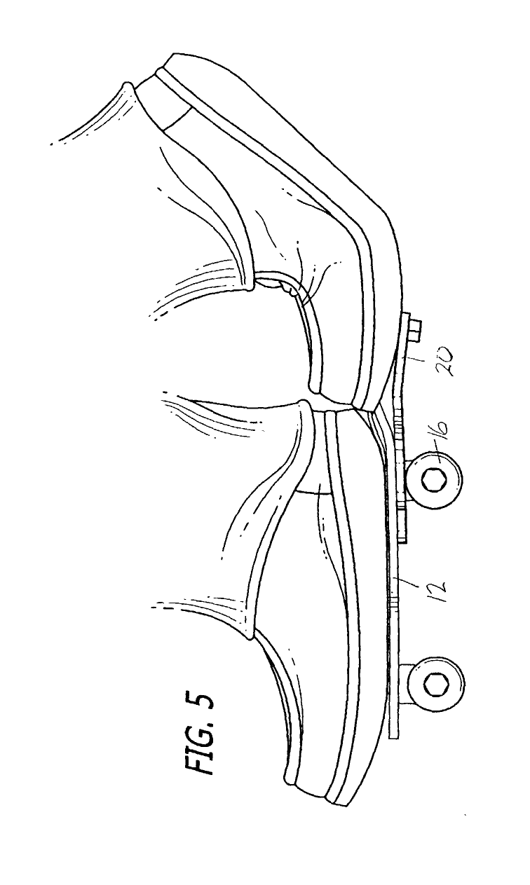

The dimensions of the support member 20 in the second (or extended) position provide for the disposition of the sole of one of the user's shoes on the support member 20 when the rear portion of the other one of the user's shoes is disposed on the platform 12 (see (FIG. 5). For example, the support member 20 may have a length less than approximately two inches (2″) beyond the rear end of the platform in the second position of the support member and may have a width less than approximately two inches (2″) in the second position of the support member. In this way, the skateboard 10 is able to coast with both feet of the user supported on the skateboard. This facilitates the ability of the user to coast on the skateboard 10 and to perform stunts on the skateboard.

A clip 26 is disposed on the upper surface of the platform 12 at a position to the rear of the pivot pin 18. The clip 26 is constructed to retain the miniature skateboard 10 in coupled relationship to the user's pants belt strap 30 or another part of the user's body when the user is not operating the miniature skateboard. This provides a distinctive advantage over the skateboards of the prior art.

When the user desires to operate the skateboard 10, the user pivots the support member 20 from the first position shown in FIG. 1 to the second position shown in FIG. 2. This pivotal movement is indicated by arrows 32 in FIG. 2. In this relationship of the skateboard 10, the user disposes the rear portion of one foot on the skateboard and moves the skateboard along a support surface 40 by pedaling with his second foot alternately on and off the support surface. In this relationship, the support member 20 also acts as a brake when depressed. In this way, the support member is able to slow or stop the skateboard.

When the user has accelerated the skateboard 10 in this manner to a desired speed, the user may coast along the support surface 40 by disposing the sole of his second foot on the support surface 40. When the user discontinues his operation of the skateboard 10, the user pivots the support member 20 to the position shown in FIG. 1. The user may then couple the clip 26 to his belt 30 or some other part of his clothing.

Although this invention has been disclosed and illustrated with reference to a particular embodiment, the principles involved are capable of being used in numerous other embodiments which will be apparent to persons of ordinary skill in the art. The invention is, therefore, to be limited only as indicated by the scope of the appended claims.

What is claimed is:

1. A miniature skateboard, including
a platform having a size preferably less than that of a user's shoe and having an upper surface for supporting the user when the user stands with one foot on the platform and having a lower surface,
a pair of axles spaced from each other in a longitudinal direction of the platform and supported on the lower surface of the platform,
a pair of wheels, each pair being disposed on an individual one of the axles and the wheels on each pair being spaced from each other in a lateral direction, and
a support member coupled to the platform and movable relative to the platform between first and second positions, the support member being disposed in the first position under the platform and being operative in the second position to provide a support for the other one of the user's feet in back of the one foot on the platform.

2. A miniature skateboard as set forth in claim 1 wherein
a pivot pin is supported by the platform and wherein the support member is supported on the pin and is pivotable between the first and second positions.

3. A miniature skateboard as set forth in claim 1 wherein
the support member is manually pivotable by the user between the first and second positions.

4. A miniature skateboard as set forth in claim 1 wherein
a clip is disposed on the upper surface of the platform to provide for the attachment of the skateboard to clothing of the user.

5. A miniature skateboard as set forth in claim 1 wherein
pivot pin is supported by the platform and wherein the support member is supported on the pin and is pivotable between the first and second positions and wherein
the support member is manually pivotable by the user between the first and second positions and wherein
a clip is disposed on the upper surface of the platform to provide for the attachment of the skateboard to clothing of the user.

6. A miniature skateboard including,
a platform having upper and lower surfaces for receiving one of the user's feet on the upper surface of the platform, the platform having a size preferably less than the size of one of the user's feet,
axle assemblies disposed on the bottom surface of the platform,
wheels attached to the axle assemblies for moving the platform, and
a support member coupled to the platform and movable between a first position corresponding substantially to the position of the platform and a second position extending rearwardly from the platform to provide a support for the other one of the user's feet when the skateboard is moving without any acceleration provided by the user.

7. A miniature skateboard as set forth in claim 6 wherein
the support member is disposed in the second position relative to the platform to define a rearward extension of the platform for supporting the user's other foot.

8. A miniature skateboard as set forth in claim 6 wherein
the support member is pivotable relative to the platform between the first and second positions.

9. A miniature skateboard as set forth in claim 6 wherein
the support member is disposed under the platform in the first position of the support member and wherein the support member is shaped to support the user's other foot in the second position of the support member.

10. A miniature skateboard as set forth in claim 6 wherein
a clip is attached to the skateboard to provide for a disposition of the skateboard on the user when the skateboard is not in use.

11. A miniature skateboard as set forth in claim 6 wherein
the support member is pivotable relative to the platform between the first and second positions and wherein a pivot pin is provided on the platform at a position near the rear end of the platform to support the support member and provide for a pivotable movement of the support member between the first and second positions.

12. A miniature skateboard as set forth in claim 7 wherein
the support member is pivotable relative to the platform between the first and second positions and wherein
the support member is disposed under the platform in the first position of the support member and the support member is shaped to support the user's other foot in the second position of the support member and wherein
a clip is attached to the skateboard to provide for a disposition of the skateboard on the user when the skateboard is not in use and wherein
the support member is pivotable relative to the platform between the first and second positions and wherein a pivot pin is provided on the platform at a position near the rear end of the platform to support the support member and provide for a pivotable movement of the support member between the first and second positions.
